(19) United States
(12) Patent Application Publication
(10) Pub. No.: US 2025/0048949 A1
(43) Pub. Date: Feb. 13, 2025

(54) Rapid Aeration Injection Device (RAID) System for Tined Aeration Systems and Farm Implements

(71) Applicants: Michael F. Forostoski, Boerne, TX (US); Justin Hardwick, Vernon, CO (US); Jason Hardwick, Vernon, CO (US)

(72) Inventors: Michael F. Forostoski, Boerne, TX (US); Justin Hardwick, Vernon, CO (US); Jason Hardwick, Vernon, CO (US)

(21) Appl. No.: 18/798,668

(22) Filed: Aug. 8, 2024

Related U.S. Application Data
(60) Provisional application No. 63/518,269, filed on Aug. 8, 2023.

(51) Int. Cl. A01B 45/02

(52) U.S. Cl. CPC A01B 45/02

(57) ABSTRACT

A rapid aeration injection device (RAID) system configured to be implemented with an aeration machine is described. Embodiments of the RAID system can include a holding tank, a pump system, and a plurality of hoses. The pump system can be configured to deliver a slurry (or other liquid, air, etc.) to tines of the aeration machine via the plurality of hoses. The pump system can be operatively coupled to a powertrain of the aeration machine to power pumps of the pump system.

### CROSS-REFERENCE TO RELATED APPLICATION

This application claims the benefit of U.S. Provisional Application No. 63/518,269, filed Aug. 8, 2023.

### BACKGROUND

Currently available injection devices, such as that found in prior art patent U.S. Pat. No. 9,560,797 (AQUA CENTS), consist of bespoke pieces of equipment and a time-consuming method for application. The method described in the prior art focuses primarily on water retention in the soil, ensuring a uniformly distributed layer of hydrogel. Currently available injection systems are inadequate for those in the turf management industry. Critical limiting factors present themselves with current art up to and including (i) current systems being slow and cumbersome, and (ii) current systems requiring a single custom piece of equipment.

A system that adds functionality to existing equipment and thus benefiting those who have already purchased a tined aeration device or farm implement and can rapidly aerate via an injection device is needed.

### BRIEF DESCRIPTION OF THE DRAWINGS

FIG. 1 is a block diagram of a rapid aeration injection device system according to one embodiment of the present invention.

FIG. 2 is a perspective view of a pump system according to one embodiment of the present invention.

FIG. 3A is a perspective view of a pump system according to one embodiment of the present invention.

FIG. 3B is a front perspective view of a rapid aeration injection device according to one embodiment of the present invention.

FIG. 3C is a back perspective view of a rapid aeration injection device according to one embodiment of the present invention.

FIG. 4A is a side view of a pump system according to one embodiment of the present invention.

FIG. 4B is a perspective view of a pump system according to one embodiment of the present invention.

### DETAILED DESCRIPTION

Embodiments of the present invention can be implemented to provide a mechanism and method to utilize existing tined aeration systems to rapidly inject a slurry, liquid containing diffused air, and/or air sub-surface into soil. In one embodiment, a rapid aeration injection device (RAID) system for attachment to aeration equipment and farm implements that have tines can be provided. In general, the RAID system can be retrofitted to existing equipment that implements tines for penetrating soil. The agricultural slurry, air, and/or liquid containing diffused air can be injected sub-surface into soil to provide water and nutrient retention enhancement, soil structure, and biology. Of note, the RAID system can rapidly inject liquids of varying viscosities and functions sub-surface.

In one instance, the RAID system can be implemented to inject quantities of biologically-active slurry beneath the soil in a semi-precise manner. Of note, water and nutrient retention can be a secondary objective and benefit of the RAID system. In one instance, the RAID system can be an “add-on” system for currently available tined aeration equipment (e.g., Toro ProCore 648) which many landscapers/groundskeepers already utilize to treat turf on golf courses, playing fields, and lawns. The RAID system can permit original functionality and speed of aeration equipment as designed, but also add injection and forced aeration features.

In general, the RAID system can be implemented as a modification for tined aeration systems (or farm implements having tines) that utilize (i) a camshaft (or crankshaft powered by the main crankshaft) of an aeration device, or (ii) the power take-off output shaft of a tractor. Of significant note, embodiments of the RAID system can be implemented in multiple variations that may allow for multiple configurations by a user to retrofit the RAID system to their specific equipment.

In one embodiment, the RAID system may implement a mechanically driven hydraulic apparatus. For instance, a mechanically driven pump can siphon a slurry from a holding tank and feed the slurry through a hose directly to a tine of bespoke design for injection into the ground. In another embodiment, the RAID system may implement an electronically driven and/or actuated hydraulic apparatus. In yet another embodiment, the RAID system may implement a mechanically driven hydraulic apparatus (e.g., slurry pump) in combination with a mechanically driven air pump apparatus. Of note, each of components may be mechanically or electrically driven. In most instances where the RAID system is implemented with an existing tined aeration device, the components may be mechanically driven.

In one embodiment, the RAID system can implement a mechanically driven hydraulic apparatus utilizing a camshaft design. A camshaft may have cams at various offsets that can engage one or more pistons located in hydraulic cylinders via one or more roller bearings. Typically, the camshaft apparatus can be mounted to an aerating device. In a typical operation, as the camshaft rotates, the roller bearing on an end of a piston rod can follow a profile of an adjacent cam, thus moving the piston. A spring utilized for piston return can be mounted inside a fill chamber of a hydraulic cylinder. It is to be appreciated one may use an externally mounted spring with some modification as needed.

In this configuration, a viscous fluid may be initially fed under pressure from a holding tank to the cylinders through one-way ball check valves to prime the system. Once primed, the pistons of the RAID system can provide suction to pull the viscous fluid from the holding tank to fill the cylinders. Once the cylinders are full, the viscous fluid may then be force-fed through a high-pressure hose to a tine of bespoke design, and into the ground at a fixed pressure and depth determined by the user. The tine may utilize a depth adjustability configured into the machine (or equipment) from an original manufacturer. Of note, the cams can be shaped to enable a forceful exit of fluid from the cylinder at a certain point. This can be timed to when the tine may be at a deepest point in the soil for the tine. As can be appreciated, a depth of the tine penetrating soil can be determined by the limitations of the aeration machine. In another configuration, a crankshaft can take the place of the camshaft and be connected to the pistons via piston rods, similar to that of an internal combustion engine. It should be appreciated there could be multiple configurations of the camshaft apparatus utilizing several methods to drive the pistons.

In another embodiment, the RAID system can implement a mechanically driven slurry pump and a mechanically driven air pump (e.g., camshaft apparatus similar to first configuration). The mechanically driven air pump can be implemented to drive air and slurry separately in a timed manner. In such a configuration, slurry can be forced into a tine via a mechanical pump first (e.g., a peristaltic pump), then a mechanically driven piston can drive air behind the slurry through the tine and provide further force to inject the slurry into the ground. It can be appreciated that one mechanical slurry pump can drive one tine at a time, or multiple tines simultaneously. Of note, each of the peristaltic pumps can implement bearings and a roller to enable rapid rotation and force against a peristaltic tube of the pump. The peristaltic tube assembly can implement a check valve to prevent line surge in case of an over-pressure scenario. Of note, a tine that can be hollow to enable slurry to pass through and exit one or more ports of the tine can be implemented.

In yet another embodiment, the RAID system can implement a plurality of mechanically driven pumps (e.g., peristaltic pumps). The pumps can be implemented to siphon slurry from a holding tank and feed the slurry through a hose directly to a tine of bespoke design for injection into the ground. In this configuration, an injection pressure of the slurry can be solely reliant on the pressure generated from the pumps. It should be appreciated this design may be modified substantially to facilitate mounting to machines of various designs.

Embodiments of the RAID system can (i) utilize an original manufacturer's depth adjustability, (ii) utilize the manufacturer's power and speed variability, and (iii) be implemented for soil disturbance management. The RAID system can be configured with air cylinders to enable further forced sub-surface aeration of the root zone in addition to active aeration from diffused oxygen water or passive aeration via the tines. As can be appreciated, this can enhance an ability of the injection to mitigate anaerobic pathogens contained in the soil and also improve vitality of the turf by providing air to the root zone. Embodiments of the RAID system can be designed to apply a slurry sub-surface to various agricultural, recreational, and residential soils to provide beneficial effects. The slurry may be comprised of components that improve soil structure and biology, enhance water and nutrient retention, and promote healthier soil.

In one embodiment, the RAID system can be a modification mounted to a tined aeration system (or farm implement) to provide the function of aeration and rapid injection of liquids with varying viscosities sub-surface into soil. The RAID system can be scaled to fit a small self-propelled tined aerator. The RAID system can be scaled to fit a tractor-pulled system driven by a PTO shaft designed for treating multiple acres. The RAID system can be implemented to utilize the original manufacturer's tine depth adjustability to inject liquids and slurries at preferred depths by the user. The RAID system may include a mechanically driven hydraulic apparatus. The RAID system may include a mechanically driven hydraulic apparatus coupled with a mechanically driven air compressor apparatus. The RAID system may include an electronically driven and/or actuated hydraulic apparatus. The RAID system can have multiple configurations based on manufacturing techniques utilized, such as a cam-to-bearing or crankshaft-to-piston rod design. In one embodiment, the RAID system can implement a cammed design and can utilize various cam profiles to suit a variety of application strategies with varying parameters for quantity of viscous fluid administered as well as injection pressure.

### Terminology

The terms and phrases as indicated in quotation marks (“ ”) in this section are intended to have the meaning ascribed to them in this Terminology section applied to them throughout this document, including in the claims, unless clearly indicated otherwise in context. Further, as applicable, the stated definitions are to apply, regardless of the word or phrase's case, to the singular and plural variations of the defined word or phrase.

The term “or” as used in this specification and the appended claims is not meant to be exclusive; rather the term is inclusive, meaning either or both.

References in the specification to “one embodiment”, “an embodiment”, “another embodiment, “a preferred embodiment”, “an alternative embodiment”, “one variation”, “a variation” and similar phrases mean that a particular feature, structure, or characteristic described in connection with the embodiment or variation, is included in at least an embodiment or variation of the invention. The phrase “in one embodiment”, “in one variation” or similar phrases, as used in various places in the specification, are not necessarily meant to refer to the same embodiment or the same variation.

The term “couple” or “coupled” as used in this specification and appended claims refers to an indirect or direct physical connection between the identified elements, components, or objects. Often the manner of the coupling will be related specifically to the manner in which the two coupled elements interact.

The term “directly coupled” or “coupled directly,” as used in this specification and appended claims, refers to a physical connection between identified elements, components, or objects, in which no other element, component, or object resides between those identified as being directly coupled.

The term “approximately,” as used in this specification and appended claims, refers to plus or minus 10% of the value given.

The term “about,” as used in this specification and appended claims, refers to plus or minus 20% of the value given.

The terms “generally” and “substantially,” as used in this specification and appended claims, mean mostly, or for the most part.

Directional and/or relationary terms such as, but not limited to, left, right, nadir, apex, top, bottom, vertical, horizontal, back, front and lateral are relative to each other and are dependent on the specific orientation of an applicable element or article, and are used accordingly to aid in the description of the various embodiments and are not necessarily intended to be construed as limiting.

### An Embodiment of a Rapid Aeration Injection Device System

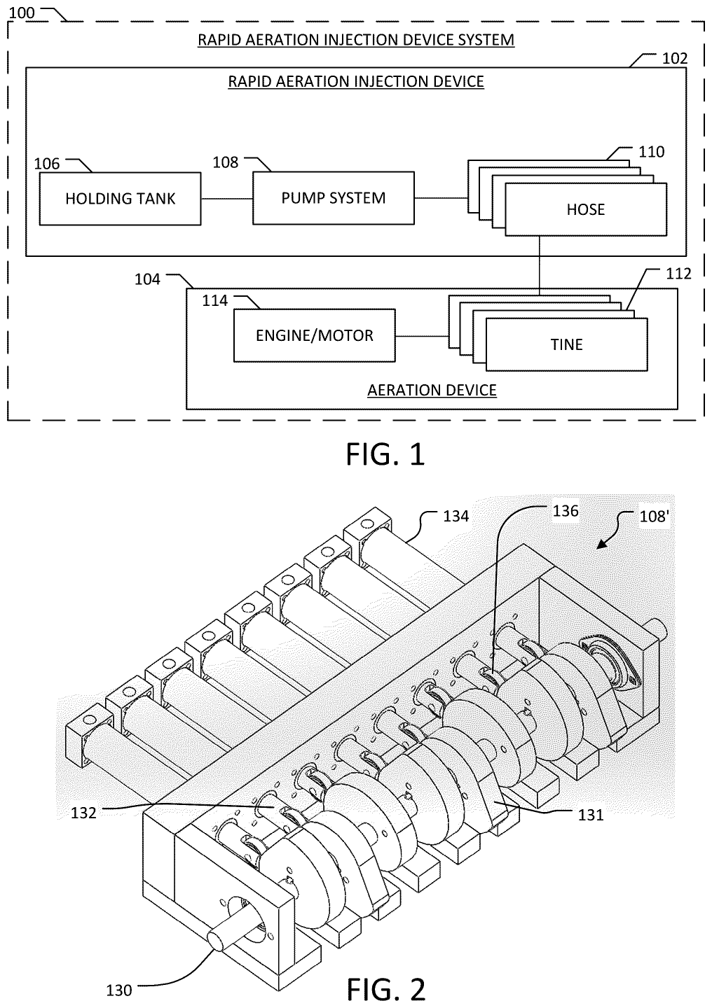

Referring to FIG. 1, a block diagram of an embodiment 100 of a rapid aeration injection device (RAID) system is illustrated. The RAID system 100 can be implemented to modify (or retrofit) an existing aeration device with the capability of injecting a fluid and gas into the ground. The system 100 can be retrofitted to a plurality of differently sized aeration devices (or machines).

The RAID system 100 can include a rapid aeration injection device (RAID) 102 operatively coupled to an aeration machine 104. Typically, the RAID 102 can be retrofitted to an existing aeration machine. The RAID 102 can be configured to provide a slurry (or fluid) to the aeration machine 104 during an aeration process. For example, when a tine of the aeration machine 104 is pressed into the ground to remove a plug of earth, the RAID 102 can be configured to deliver the slurry subsurface of the ground as the plug of earth may be removed.

As shown, the RAID 102 can include, but is not limited to, a holding tank 106, a pump system 108, and a plurality of hoses 110. The holding tank 106 can be configured to store a slurry (or fluid) for delivery subsurface of the ground. The pump system 108 can be configured to transfer the slurry (or other fluid) from the holding tank 106 to tines of the aeration machine 104 via the plurality of hoses 110. Of note, the pump system 108 can be operatively connected to a drivetrain of the aeration machine 104. As can be appreciated, this can allow for the RAID 102 to be implemented with pre-existing aeration machines that are configured to aerate a lawn by removing plugs of earth from the ground. Of significant note, the RAID 102 can allow for slurry to be delivered via the aeration machine 104 at a normal operation rate of the aeration machine 104. Stated alternatively, the aeration machine 104 can be operated as normal while allowing for a slurry to be delivered subsurface at a rate that the aeration machine 104 removes plugs of earth.

The aeration device 104 can include a plurality of tines 112 fluidly connected to the pump system 108 via the plurality of hoses 110. Typically, one of the plurality of hoses 110 can be connected to one of the plurality of tines 112. In some embodiments, the plurality of tines 112 may be provided as part of the RAID 102. In other embodiments, tines already associated with an aeration device may be capable of delivering a slurry.

The aeration machine 104 can typically include an engine (or motor) 114 for driving the tines into the ground. The pump system 108 can be operatively connected to the engine 114 to power the pump system 108. For instance, a component (e.g., a camshaft) of the engine 114 can be coupled to the pump system 108. In general, the engine 114 can be implemented to help time an injection of a slurry into the ground. For instance, an activation of the pump system 108 (e.g., the pump pushes slurry to a tine) can be based on a coupling of the pump system 108 to a camshaft of the engine 114. Of note, the powertrain (engine or motor) of the aeration machine 104 can be configured to power and time the RAID 102.

In one embodiment, the RAID system 100 may implement a mechanically driven hydraulic apparatus for the pump system 108. For instance, a mechanically driven pump can siphon a slurry from the holding tank 106 and feed the slurry through the hoses 110 directly to the tines 112 of the aeration machine 104 for injection into the ground. In another embodiment, the RAID system 100 may implement an electronically driven and/or actuated hydraulic apparatus for the pump system 108. In yet another embodiment, the RAID system 100 may implement a mechanically driven hydraulic apparatus (e.g., slurry pump) in combination with a mechanically driven air pump apparatus. Of note, each of components of the RAID system 100 may be mechanically or electrically driven.

Referring to FIG. 2, one example embodiment 108′ of the pump system 108 implementing a mechanically driven hydraulic pump utilizing a camshaft design is illustrated. The pump system 108′ can implement a camshaft 130 that can have cams 131 at various offsets. The cams 131 of the camshaft 130 can engage one or more piston rods 132 located in hydraulic cylinders 134 via one or more roller bearings 136. In a typical operation, as the camshaft 130 rotates, a roller bearing 136 on an end of a piston rod 132 can follow a profile of an adjacent cam 131, thus moving the piston rod 132. A spring (not shown) utilized to return the piston rod 132 can be mounted inside a fill chamber of the hydraulic cylinder 134. It is to be appreciated one may use an externally mounted spring with some modification as needed. Of note, the camshaft 130 can be operatively connected to a powertrain of the aeration machine engine 114. The engine 114 may then be implemented to power the RAID 102.

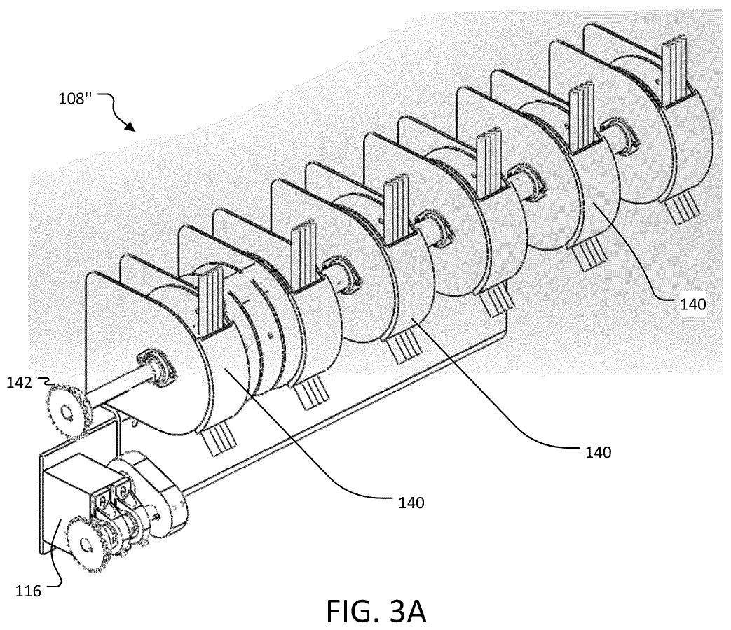

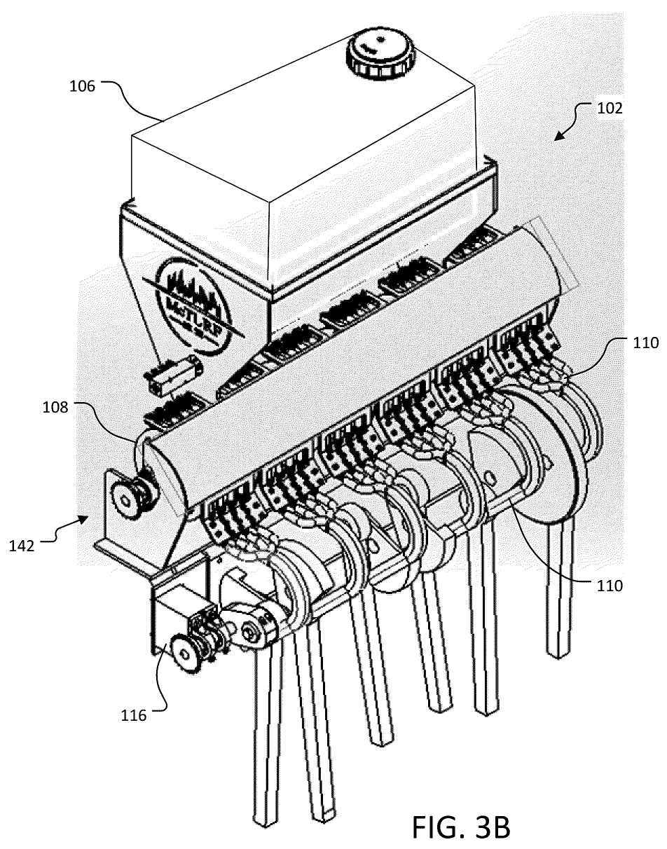

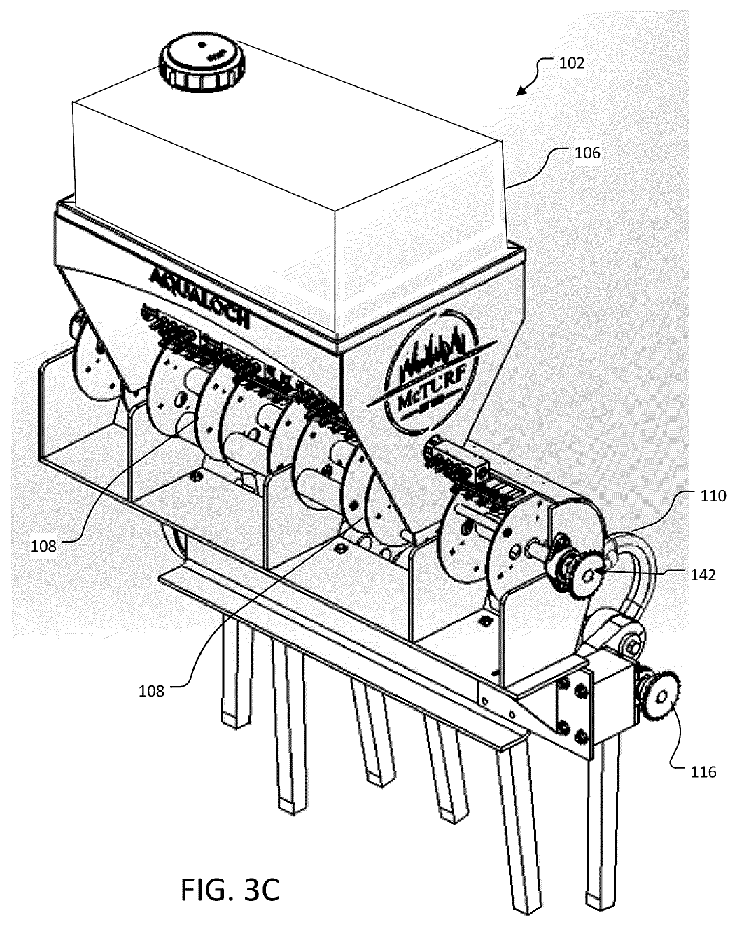

Referring generally to FIGS. 3A-3C, various views of a second example embodiment 108″ of the pump system 108 is illustrated. FIG. 3A shows a perspective view of the second example embodiment pump system 108″. FIGS. 3B-3C show perspective views of the second example embodiment pump system 108″ being implemented with the RAID 102. Typically, the second example embodiment pump system 108″ can implement a plurality of peristaltic pumps 140 and a mounting system 142 for operatively coupling the pump system 108″ to a drivetrain 116 of the aeration machine 104. Of note, the peristaltic pumps can be configured to pump slurry from the holding tank 106 based on when an associated tine would be inserted into the ground. In this configuration, an injection pressure of the slurry can be solely reliant on the pressure generated from the peristaltic pumps 140. It should be appreciated this design may be modified substantially to facilitate mounting to machines of various designs.

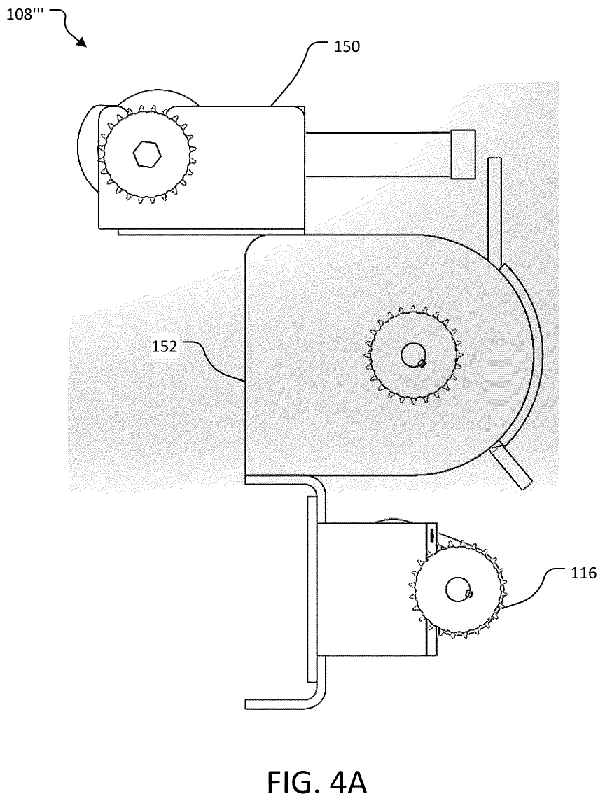

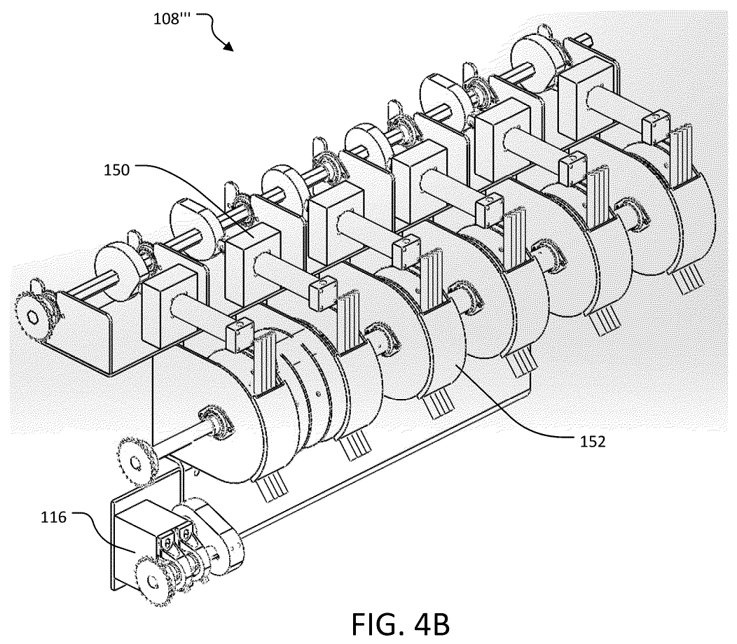

Referring to FIGS. 4A-4B, various views of a third example embodiment 108′″ of the pump system 108 are illustrated. FIG. 4A includes a side view of the third example embodiment pump system 108′″. FIG. 4B includes a perspective view of the third example embodiment pump system 108′″. The pump system 108′″ can implement a mechanically driven slurry pump 150 (e.g., peristaltic pump) and a mechanically driven air pump 152 (e.g., camshaft driven pump similar to first embodiment pump system 108′). The mechanically driven air pump 152 can be implemented to drive air and slurry separately in a timed manner. In such a configuration, slurry can be forced into a tine via the mechanical pump first 152, then the mechanically driven piston 150 can drive air behind the slurry through the tine and provide further force to inject the slurry into the ground. It can be appreciated that one mechanical slurry pump can drive one tine at a time, or multiple tines simultaneously.

### Alternative Embodiments and Variations

The various embodiments and variations thereof, illustrated in the accompanying Figures and/or described above, are merely exemplary and are not meant to limit the scope of the invention. It is to be appreciated that numerous other variations of the invention have been contemplated, as would be obvious to one of ordinary skill in the art, given the benefit of this disclosure. All variations of the invention that read upon appended claims are intended and contemplated to be within the scope of the invention.

I claim:

1. A rapid aeration injection device (RAID) system for use with a tined aeration machine, the RAID system comprising:
a holding tank adapted to be coupled to the tined aeration machine;
a pump system in fluid connection with the holding tank, the pump system operatively connected to a drivetrain of the tined aeration machine; and
a plurality of hoses each having (i) a first end fluidly connected to the pump system and (ii) a second end fluidly connected to one of a plurality of tines of the tined aeration machine.

2. The RAID system of claim 1, wherein the pump system further includes a plurality of mechanically driven air pumps.

3. The RAID system of claim 1, wherein the pump system further includes a plurality of electronically driven air pumps.

4. The RAID system of claim 1, wherein the pump system includes a plurality of mechanically driven pumps.

5. The RAID system of claim 4, wherein each of the plurality of mechanically driven pumps are peristaltic pumps.

6. The RAID system of claim 1, wherein the holding tank is adapted to store a slurry.

7. The RAID system of claim 1, wherein the drivetrain powers the pump system.

8. The RAID system of claim 1, wherein the pump system includes a plurality of mechanically driven hydraulic pumps adapted to interface with a camshaft.

9. The RAID system of claim 1, wherein the pump system includes a plurality of mechanically driven air pumps and a plurality of mechanically driven peristaltic pumps.

10. A rapid aeration injection device (RAID) system in combination with an aeration machine, the RAID system comprising:
a holding tank;
a pump system in fluid connection with the holding tank, the pump system adapted to be operatively connected to a drivetrain of the aeration machine; and
a plurality of hoses each having (i) a first end fluidly connected to the pump system and (ii) a second end adapted to be fluidly connected to one of a plurality of tines of the aeration machine.

11. The RAID system of claim 10, wherein the pump system further includes a plurality of mechanically driven air pumps.

12. The RAID system of claim 11, wherein the pump system is adapted to deliver the slurry and then air from the plurality of mechanically driven air pumps.

13. The RAID system of claim 10, wherein the pump system includes a plurality of mechanically driven pumps.

14. The RAID system of claim 13, wherein each of the plurality of mechanically driven pumps are peristaltic pumps.

15. The RAID system of claim 10, wherein the holding tank is adapted to store a slurry.

16. The RAID system of claim 10, wherein the drivetrain powers the pump system.

17. The RAID system of claim 10, wherein the pump system includes a plurality of mechanically driven hydraulic pumps adapted to interface with a camshaft.

18. The RAID system of claim 10, wherein the pump system includes a plurality of mechanically driven air pumps and a plurality of mechanically driven peristaltic pumps.

19. A rapid aeration injection device (RAID) system for use with an aeration machine, the RAID system comprising:
a holding tank adapted to store a slurry;
a pump system in fluid connection with the holding tank, the pump system (i) including a plurality of peristaltic pumps, (ii) adapted to be operatively connected to a drivetrain of the aeration machine; and (iii) including a plurality of mechanically driven air pumps; and
a plurality of hoses each having (i) a first end fluidly connected to the pump system and (ii) a second end adapted to be fluidly connected to one of a plurality of tines of the aeration machine.

20. The RAID system of claim 19, wherein the plurality of mechanically driven air pumps are adapted to interface with a camshaft and provide an additional injection force for the slurry.
